(19) United States
(12) Patent Application Publication
(10) Pub. No.: US 2011/0010360 A1
(43) Pub. Date: Jan. 13, 2011

(54) RESTRICTING QUERIES BASED ON COST OF PERFORMANCE

(76) Inventors: DINA A.M. AYOUB, BELLEVUE, WA (US); MINGQUAN XUE, REDMOND, WA (US); WILLARD BRUCE JONES, REDMOND, WA (US); NARESH KANNAN, SEATTLE, WA (US); ANDREW SEAN WATSON, SEATTLE, WA (US); SIMON SKARIA, SAMMAMISH, WA (US)

Correspondence Address: MERCHANT & GOULD (MICROSOFT), P.O. BOX 2903, MINNEAPOLIS, MN, 55402-0903, US

(21) Appl. No.: 12/501,318

(22) Filed: Jul. 10, 2009

(51) Int. Cl. G06F 17/30

(52) U.S. Cl. 707/719; 707/E17.017; 707/E17.005

(57) ABSTRACT

Queries that are determined to be too expensive to perform are prevented from being executed. Queries are determined to be too expensive based on the resources that are required to perform the query. For example, the query may be determined to be too expensive to perform based a length of a list the query requires to access, a number of lookups that may be performed relating to the query, a number of unique permissions accessed by the query, and the like. Queries that are deemed to expensive during normal operation may be performed during other times such that the impact of performing the query on other users is limited.

### BACKGROUND

Some queries to a server can cause performance degradation of the server by demanding too many resources. This performance degradation negatively affects an end user experience. For example, a query can cause the server to lock out other queries from being performed until the current query is performed. At some point when the query causes the server to access a data set that requires too much work to access, the server may become completely unresponsive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Queries that are determined to be expensive to perform are prevented from being executed. Queries may be determined to be expensive based on the resources that are required to perform the query. The determination of the expense may be performed at different times depending on the implementation. For instance the expense may be determined at permission addition time during schema management and/or at data retrieval time. The query may be determined to be expensive to perform based on may different items, such as: on a length of a list the query requires to access, a number of lookups/joins that are to be performed when the query is performed, a number of unique permissions created by the query, a number of database rows used to store an item in a list, and the like. Queries that are deemed too expensive to perform during normal operation hours may be performed during other times such that the impact of performing the query on other users is limited.

### BRIEF DESCRIPTION OF THE DRAWINGS

FIG. 1 illustrates a computer architecture for a computer;

FIG. 2 shows a system for restricting the execution of a query that is determined to be expensive;

FIG. 3 illustrates a process for restricting the execution of expensive queries; and

FIG. 4 shows a process for determining a cost of a query.

### DETAILED DESCRIPTION

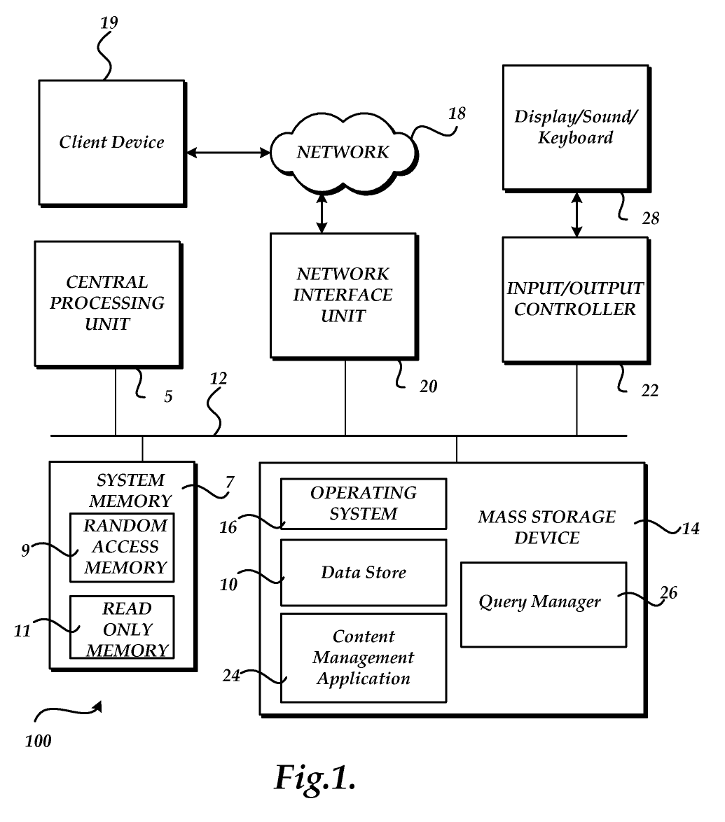

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop, a server, or mobile computer and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage mediums and communication media. Computer storage mediums includes volatile and non-volatile, removable and non-removable media implemented in any method or technology for storage of information such as computer-readable instructions, data structures, program modules or other data. Computer storage mediums include, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen that includes a user interface 28, a printer, or other type of output device. User interface (UI) 28 is designed to provide a user with a visual way to interact with application 24, as well as to interact with other functionality that is included on computing device 100.

As mentioned briefly above, a number of program modules and data files may be stored in the mass storage device 14 and RAM 9 of the computer 100, including an operating system 16 suitable for controlling the operation of a networked computer, such as the WINDOWS 7® or WINDOWS SERVER® operating systems from MICROSOFT CORPORATION of Redmond, Wash. The mass storage device 14 and RAM 9 may also store one or more program modules. In particular, the mass storage device 14 and the RAM 9 may store one or more application programs. One of the application programs is a content management application 24, such as MICROSOFT SHAREPOINT®.

Computing device 100 may be configured to provide site services for client devices, such as client device 19. For example, server 100 may be configured to provide a site that is accessed through a browser application on client 19. According to one embodiment, site software, such as MICROSOFT SHAREPOINT SERVICES®, may be used. In an embodiment of the invention, data store 10 is a relational database, such as MICROSOFT SQL SERVER®. In alternative embodiments of the invention, database systems such as Oracle, Informix or Sybase can be used. The invention is not limited to any particular type of database system. Client 19 may utilize a web browser application and/or some other application to access the data stored within data store 10.

Query manager 26 provides functionality to limit expensive queries from being performed during predetermined times. Queries may be determined to be expensive by query manager 26 based on different conditions. Generally, a query is too expensive to be performed when the query would result in a number of database reads and/or database inquiries that exceed a predetermined threshold. According to one embodiment, the query is too expensive to be performed when the query attempts to retrieve, update, or in any way affect a very large a list, and/or the query exceeds a number of lookups/joins, and/or the query results in a large number of unique permissions on the list, a number of database rows used to store an item in a list, an amount of memory used, and the like. More detail on operation of query manager 26 is provided below.

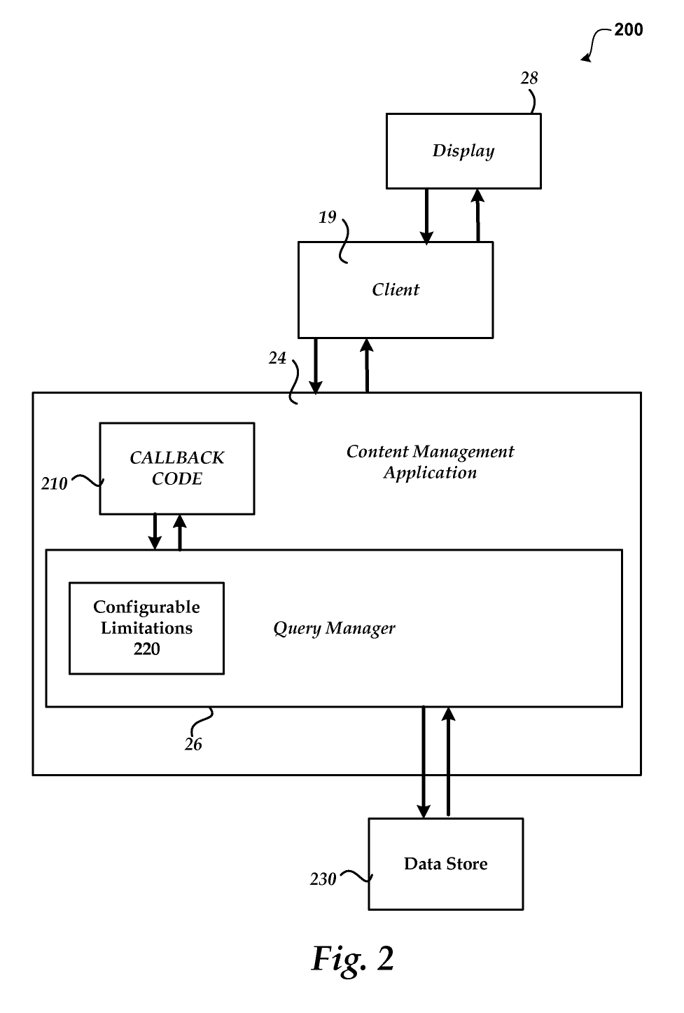

FIG. 2 shows a system for restricting the execution of a query that is determined to be expensive. As illustrated, system 200 includes display 28, client 19, content management application 24, and data store 230. Query manager 26 may be implemented within application 24 as shown in FIG. 2 or may be implemented externally from application 24 as shown in FIG. 1.

In order to facilitate communication with the query manager 26, one or more callback routines, illustrated in FIG. 2 as callback code 210, may be implemented. Through the use of the callback code 210, the query manager 26 may query content management application 24 for additional information used in determining whether or not to restrict a query from being executed.

Query manager 26 is configured to assist in preventing expensive queries from being executed such that a server remains responsive to other queries. Generally, query manager 26 is configured to prevent queries that would cause the server to exceed a predetermined number of IOPS (Input/Output Operations Per Second) while executing the query. According to one embodiment, query manager 26 prevents queries from running that attempt to retrieve, update, or in any way affect more than 5000 rows in a data store, such as data store 230, at a time. The row limit of 5000 is a default row limit and is configurable by an authorized user. This row limit value is stored in configurable limitations 220.

Query Manager 26 is also configured to prevent/limit a query from being executed that exceeds a predetermined number of joins (lookups) that are to be performed on non single-item queries. Query manager 26 may limit a query by returning a subset of the fields requested and/or return data that is locally stored. For example, the query may be limited based on an amount of available resources. This maximum lookup value (default value of six) is also stored in configurable limitations 220 and is configurable by an authorized user. Limiting the number of lookups reduces the load on the server that could result from too many joins in a single query.

The query manager 26 also limits the number of unique permissions allowed per list (default value of 50,000). This unique permission limitation helps to ensure that the query size does not become excessively large such that the load on the server is minimized due to single permission checks. The permission limitation value is also stored in the configurable limitations 220 and is configurable by an authorized user.

When a query is received from client 19 that attempts to retrieve, update, or in any way affect more than the row limit in a single table at a time the query is prevented from being executed. According to one embodiment, a different row limit is associated with different types of users. For example, a super user may have a larger limit whereas a normal user may have the default limit. When a user/application desires to perform a query that exceed this limit, a predetermined time window may be set such that users may perform these expensive operations. For example, a user may need to manage large lists in terms of making global changes such as changing a column type, or making a column indexed. Generally, this time window in which expensive queries are allowed to be performed is set to non-peak times. According to one embodiment, an authorized user may request that their query override the row limit. Additionally, each list may include a setting to indicate whether the list is not subject to the limits, and the server would allow any query to be run regardless of cost The row limit for authorized users is designed to provide flexibility for some users/applications that require larger row limits.

When the query is for a view or other operations that attempt to retrieve more than the configured limit for a number of lookup columns, the query is limited or prevented from being executed and query manager 26 may produce an error message that is displayed to the user on display 28. According to one embodiment, when no columns are specified and the list has more than the predetermined number of lookup columns, query manager 26 in conjunction with content management application 24 returns the predetermined number of lookup columns to return, and does not perform the joins for the others.

As discussed above, query manager 26 enforces a limit on the a number of unique permissions allowed per list. This means that every time inheritance is broken on permissions for an item or folder, this is counted as one unique permission. Inheritance refers to the fact that there is a hierarchy of parents and children and a child may share (or “inherit”) the permissions of its parent; where any changes in the permissions of the parent apply to its children. When inheritance is broken on a child, the permissions on the child are managed separately, and changes to the permissions of the parent have no effect on that child.

Query manager 26 is also configured to produce a warning when a limit is nearing and/or exceeding a limit. According to one embodiment, the values of when to produce warning messages is configurable. According to one embodiment, an object model is provided for interacting with settings related to the query manager. For example, an object model may be used to specify the row limit, the unique permissions limit, the join limit, request override of a limit, as well as setting the times when expensive operations can be performed.

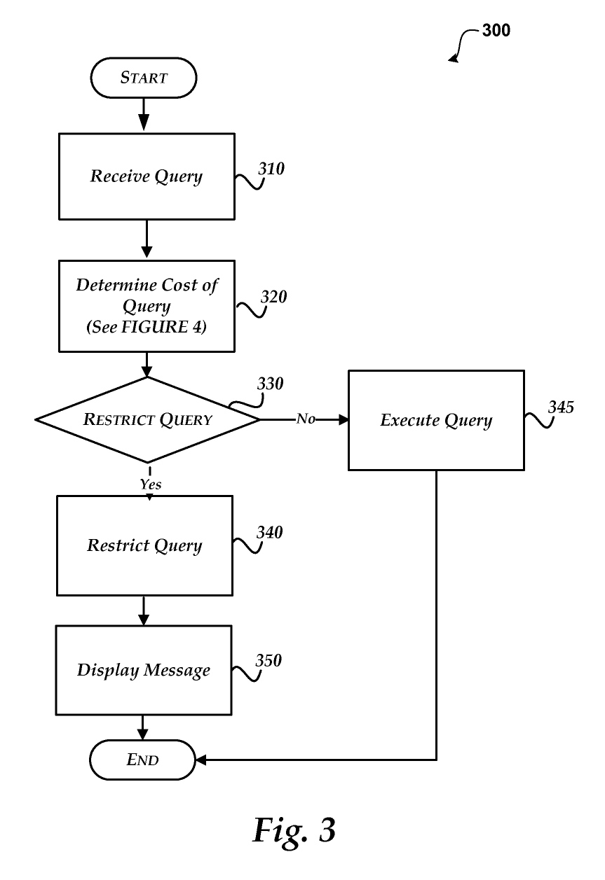

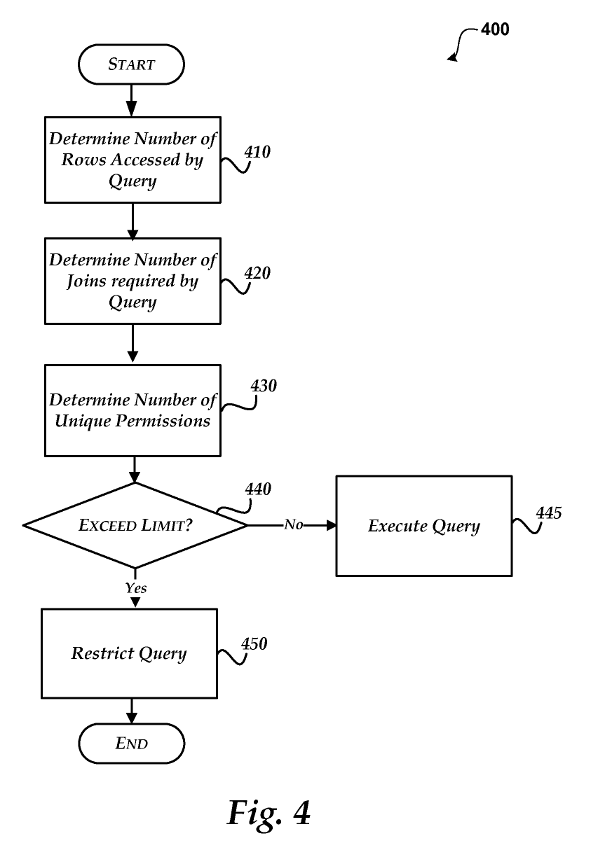

Referring now to FIGS. 3-4, illustrative processes for restricting expensive queries from being executed are described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof

FIG. 3 illustrates a process for restricting the execution of expensive queries.

After a start operation, the process flows to operation 310, where the query is received. Generally, the query is received from a user or some application that is requesting an operation to be performed on data within a data store. For example, the data may be stored in a relational database having rows and columns.

Moving to operation 320, the cost of performing the query is determined. The cost is used to determine whether the query is too expensive to perform. Generally, queries are too expensive when they require a number of operations to be performed that would significantly degrade performance of the server performing the operations. See FIG. 4 and the related discussion for more details regarding determining the cost of the query.

Flowing to decision operation 330, a determination is made as to whether to restrict the query from being executed. When a query is too expensive to perform, the process flows to operation 340. When the query is not too expensive to perform, the process flows to operation 345 where the query is executed.

At operation 340, the query is prevented from being executed. According to one embodiment, queries that are deemed to expensive may be performed during a predetermined time each day (which may change) without regard to the cost of the query.

Moving to operation 350, a warning/error message is displayed to the user. The message indicates that the query is restricted from being executed. In addition to displaying a message when the query is prevented from being executed, a warning message may be displayed when a query nears one of the predetermined limits that relate to the query.

The process then flows to an end operation and returns to processing other actions.

FIG. 4 shows a process for determining a cost of a query.

After a start operation, the process flows to operation 410, where a number of rows accessed by the query is determined. When the query attempts to retrieve, update, or in any way affect more than the predetermined row limit in a single table at a time, the query is prevented from being executed. This row limit value may be changed based on the rights of a user. For example, a super user may have a larger row limit whereas a normal user may have the default row limit.

Moving to operation 420, a determination is made as to the number of joins that are required to be performed by the query. When the query is for a view or other operations that attempt to retrieve more than the predefined number of joins, the query is prevented from being executed.

Flowing to operation 430, a determination is made as to the number of unique permissions the query affects. When the number of unique permissions exceeds the predetermined permissions limit, the query is prevented from being executed.

Decision operation 440, determines whether any of the limits are exceeded by the query. When one or more of the limits is exceeded, the process flows to operation 450, where the query is prevented from being executed. When none of the limits are exceeded, the process flows to operation 445, where the query is executed.

The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for improving performance of a server performing queries related to interacting with data in a database, the method executing on a processor of a computer, comprising:
receiving a query at the server from a client; wherein the query interacts with a list within the database;
determining a cost of the query; wherein determining the cost of the query comprises determining a cost of executing the query and determining a cost of other operations that are performed in response to running the query; and
preventing the query from executing when the cost is determined to be expensive.

2. The method of claim 1, wherein determining the cost of the query comprises determining when the query requires access to a number of rows that exceed a user configurable row limit.

3. The method of claim 1, wherein determining the cost of the query comprises determining when the query requires access to a number of unique permissions that exceed a configurable unique permissions limit.

4. The method of claim 1, wherein determining the cost of the query comprises determining when the query requires a number of joins that exceed a configurable number of joins limit.

5. The method of claim 1, wherein determining the cost of the query comprises determining: when the query requires: access to a number of rows that exceed a user configurable row limit; access to a number of unique permissions that exceed a configurable unique permissions limit; and a number of joins that exceed a configurable number of joins limit.

6. The method of claim 1, wherein determining the cost of the query comprises determining a number of database requests is required to be performed in performing the query.

7. The method of claim 1, further comprising providing a predetermined time period of a day during which the determining cost operation is not performed, wherein the predetermined time period can change day to day.

8. The method of claim 5, wherein the row limit, the permissions limit, and the joins limit is a higher value for an authorized user as compared to an non-authorized user.

9. A computer-readable storage medium having computer-executable instructions for improving performance of a server performing queries related to interacting with data in a database, the instructions executing on a processor of a computer, comprising:
receiving a query to interact with the data within the database;
determining when a query is expensive by determining a cost of executing the query that relates to a number of accesses to the database; and
preventing the query from executing when the query is determined to be expensive.

10. The computer-readable storage medium of claim 9, wherein determining when the query is expensive comprises determining when the query requires access to a number of rows that exceed a row limit.

11. The computer-readable storage medium of claim 10, wherein determining when the query is expensive comprises determining when the query requires access to a number of unique permissions that exceed a unique permissions limit.

12. The computer-readable storage medium of claim 10, wherein determining when the query is expensive comprises determining when the query requires a number of joins that exceed a number of joins limit.

13. The computer-readable storage medium of claim 9, wherein determining when the query is expensive comprises determining: when the query requires: access to a number of rows that exceed a user configurable row limit; creation of unique permissions that exceed a configurable unique permissions limit; and a number of joins that exceed a configurable number of joins limit.

14. The computer-readable storage medium of claim 13, further comprising providing a predetermined time period of a day during which the determining when the query is expensive is not performed, wherein the predetermined time period can change day to day and is set to a non-peak time.

15. The computer-readable storage medium of claim 13, further comprising utilizing an object model to override one or more of the limits.

16. A system for restricting execution of queries, comprising:
a processor and a computer-readable medium;
an operating environment stored on the computer-readable medium and executing on the processor;
a network connection;
a relational database;
a content management application and a query manager operating on the processor; and configured to perform tasks, comprising:
receiving a query to interact with data within the relational database;
determining when a query is expensive by determining a cost of the query and determining when an impact of performing the query exceeds a predetermined threshold; and
preventing the query from executing when the query is determined to be expensive.

17. The system of claim 16, wherein determining when the query is expensive comprises determining when the query requires access to a number of rows within the relational database that exceed a row limit.

18. The system of claim 17, wherein determining when the query is expensive comprises determining when the query requires a number of joins that exceed a number of joins limit.

19. The system of claim 16, wherein determining when the query is expensive comprises determining: when the query requires: access to a number of rows that exceed a user configurable row limit; access to a number of unique permissions that exceed a configurable unique permissions limit; and a number of joins that exceed a configurable number of joins limit.

20. The system of claim 19, further comprising utilizing an object model to override one or more of the limits; providing a predetermined time period of a day during which the determining when the query is expensive is not performed, wherein the predetermined time period can change day to day and is set to a non-peak time; and providing an error message when one of the limits is determined to be exceeded.
